(19) United States
(12) Patent Application Publication
(10) Pub. No.: US 2025/0196228 A1
(43) Pub. Date: Jun. 19, 2025

(54) METHOD FOR OPTIMIZING PROCESS PARAMETERS OF AN ADDITIVE MANUFACTURING PROCESS

(71) Applicant: AMIQUAM SA, Gland (CH)

(72) Inventors: Marc LANY, Rolle (CH); Bernard REVAZ, Genève (CH); Gilles SANTI, Lausanne (CH); Adriaan B. SPIERINGS, Wittenbach (CH); Marvin A. SPUREK, Zürich (CH); Jonatan WICHT, Nyon (CH); Alain BERTHOUD, Châtelaine (CH)

(73) Assignee: AMIQUAM SA, Gland (CH)

(21) Appl. No.: 18/846,374

(22) PCT Filed: Mar. 15, 2023
(86) PCT No.: PCT/IB2023/052505

§ 371 Date: Sep. 12, 2024

(30) Foreign Application Priority Data
Mar. 15, 2022 (EP) 22162312.7

(51) Int. Cl. B22F 10/80; B22F 10/31; B33Y 50/00

(52) U.S. Cl. CPC B22F 10/80; B22F 10/31; B33Y 50/00

(57) ABSTRACT

A method for optimizing one or more process parameters of an additive manufacturing process. The method includes, a. manufacturing a set of test samples (c₁ . . . c₁ . . . cₙ) on a build platform (P) of an additive manufacturing system, each test sample (c₁ . . . c₁ . . . cₙ) being monitored by at least one electromagnetic sensor for obtaining at least one optimized set of process parameters (p_{i,opt}), and storing the at least one optimized set of process parameters (p_{i,opt}) for subsequent use during the building process of the said at least one AM part, which is representative of a test coupon (c_{i,j}) of a given acceptable quality factor. The at least one optimized set of process parameters (p_{i,opt}) is obtained by carrying out the following steps: i. manufacturing at least two test coupons (c_{1,1} . . . c_{i,1} . . . c_{n,1}) with two different sets of guess process parameters (p_{1,1} . . . p_{i,1} . . . p_{n,1}), ii. sensing the two test coupons (c_{1,1} . . . c_{i,1} . . . c_{n,1}) with the at least one electromagnetic sensor, iii. changing for each new coupon at least one process parameter as a function of a) the previous sets of process parameters (p_{1,1} . . . p_{i.j} . . . P_{n,m}) for the respective built test coupons, and b) the quality factor of respective test coupons measured by the electromagnetic sensor to obtain respective new sets of process parameters (pᵢⱼ₊₁); iv. manufacturing an additional set of test coupons (c_{i,j}) of respective test samples with the respective new set of process parameters (p_{i,j}); v. sensing the additional set of test coupons (c_{i,j}) with the at least one electromagnetic sensor, and vi. repeating steps iii. to v. until a predetermined geometry of each test sample (c_{1,m} . . . c_{i,m} . . . c_{n,m}) is obtained. A process parameters' window yielding an acceptable quality factor for the at least one AM part is computed as a function of the sets of process parameters used for building the test coupons of respective test samples, and the quality factor of the test coupons. At least one optimized set of process parameters is selected within the process parameter window.

### FIELD OF THE INVENTION

The present invention relates to a method for optimizing process parameters of an additive manufacturing process using sequential, layer by layer deposition of metal or non-metal material such as SLM (Selective Laser Melting), DMLS (Direct Metal Laser Sintering), Electron Beam Melting (EBM), direct liquid metal deposition and binder jetting.

### DESCRIPTION OF RELATED ART

The recent evolution of the domain of additive manufacturing (AM) provides excellent tools not only for rapid and cost-effective manufacturing of prototypes and products but also for a single on-demand component, for a pre-production series of components and for production of a limited number of components. In particular, there is an increasing interest in manufacturing high value-added components with complex geometries that are hard or impossible to manufacture with traditional machining. However, the control of the quality of these components that have to comply with given quality standards and technical requirements so as to allow a use in highly demanding and regulated application fields is still a challenge.

In an additive manufacturing process, a manufacturing anomaly (e.g. non-intended variation of the structural, geometrical, material integrity, or material properties of the final manufactured component) could arise due to different factors, in particular a mismatch or an unintended drift of manufacturing parameters, an inconsistency in the 3-dimensional (3D) model of the component, an incorrect application of a material layer, an unintended machine condition, a flaw in the powder material, or a bad thermal management resulting in hot spots and related geometrical or material defects.

Depending on the relevance and of the typology of the variation as well as depending on the applied quality standards and technical requirements, the manufacturing anomaly can represent either an acceptable imperfection or an unacceptable flaw (a local defect, or increased material porosity) which could potentially lead to a malfunction or a premature mechanical failure of the component.

In Power Bed Fusion (PBF) applications, the melting of metal powder by an energy beam and successful mastering of the whole manufacturing procedure requires complex management, because multitudes of variables enter the additive manufacturing process.

Process parameters influence the mechanical and structural properties of the metal piece to be manufactured, and they vary depending on the kind of material used and the specific position in the part in relation to the rest of the component. For example, a change in power of the energy beam will be expressed differently in the mechanical properties of the melted material of steel, titanium or aluminium. In addition, a compromise must be found on the quality of the part to be manufactured and the process parameters influencing the speed of the additive manufacturing process for production throughput considerations. Parts which are not subjected to high mechanical stress may for example have a degree of acceptable porosity and therefore the scan speed and the layer thickness may be increased to shorten the manufacturing time. Conversely, parts subjected to high mechanical stress such as aero-engine components, or certain medical devices require very high relative density, i.e., low porosity, to avoid pre-mature failure.

Prior to printing a metal piece, it is therefore essential to determine optimal process parameters considering the above factors. For Laser Powder Bed Fusion, a way to define the process parameters consists in printing and testing samples, according to a test matrix of various combinations of laser power, laser scanning velocity, hatch distance, layer thickness combinations among other parameters. In addition, the powder properties (for instance the particle size distribution, particle morphology) and the laser scanning strategy can be integrated in the test matrix.

More particularly, several test coupons are manufactured on the build platform, whereby each test coupon is manufactured with a unique combination of influencing process parameters. The quality of each test coupon is then determined using different destructive and non-destructive techniques such as CT scanning as disclosed for example in US2020272128, optical metallography, SEM, EBSD, X-Ray diffraction, dimensional, surface metrology and the Archimedes method (for density measurement), revealing various defect types such as cracking, porosity, geometrical deviations, microstructural deviations, chemical deviations, lack of fusion, inclusions, or residual stress. Finding the optimal process parameters is therefore tedious, time consuming, and costly.

To address these problems, it is known to dispense with test coupons and to scan with sensors directly the AM part as it is being manufactured to optimize the process parameters during the manufacturing process as a function of data provided by the sensors. On-the-fly scanning methods on AM parts are disclosed for example in WO2018217903A1 and US20190004496.

These on-the-fly scanning methods have the inconvenience to be non-compliant for AM part certification as the process parameters set prior to the manufacturing of the AM part are essential to the certification. In addition, these methods may use machine learning algorithms to optimize process parameters. These machine learning algorithms are so opaque that users do not necessarily know which factor contributed to what aspect of the optimized process parameters. It is therefore difficult or impossible to ensure that AM parts produced by these methods are compliant for AM parts certification which ensures that AM parts meet the strict requirements demanded by the industry.

US20200298499 discloses an additive manufacturing method comprising the step of fabricating one or more parts of a defined geometry based on a first parameter set, the step of collecting in-situ monitoring data from one or more in-situ monitoring systems for one or more parts and the step of determining whether a stack formed from one or more of these parts should receive an additional part based on an analysis of the collected in-situ monitoring data.

This method has the disadvantage of wasting volume because of the decision not to stack additional parts, thereby reducing the sets of process parameters that can be explored. This approach may also produce inaccurate results by changing the environment of parts, for example by deciding not to produce a part in a neighbouring of the stack. These changes may prevent taking adequately into account the effect of part density on the build plate.

### BRIEF SUMMARY OF THE INVENTION

An aim of the present invention is therefore to provide a method that maximizes the information obtained about the influence of process parameter on part quality for a given measurement time and powder.

It is indeed advantageous to use multiple of test samples having each a predefined geometry and including several test coupons to increase the explored sets of process parameters to refine the optimized set of process parameters for a test coupon of optimal quality factor for the field of application of the AM part.

Another aim of the present invention is to provide a method for optimizing process parameters for AM parts of a material of a given composition in a time-efficient manner and compliant for AM part certification which ensure AM parts meet the strict quality, safety and consistency requirements demanded by the industry.

Another aim of the present invention is to provide a method for optimizing process parameters of a material of a given composition which is easy to implement.

Another aim of the present invention is to provide a method for obtaining optimized set of process parameters that can be assigned to certain regions of the AM part to be built based on explainable rules.

A further aim of the present invention is to provide a non-destructive method for optimizing process parameters of material of a given composition.

These aims are achieved by a method for optimizing one or more process parameters of an additive manufacturing process, comprising, prior to the step of manufacturing at least one AM part, the steps of: a. generating, on a computing device, a 3D digital model of a set of test samples to be manufactured by the additive manufacturing process, wherein each test sample has a predetermined geometry; b. manufacturing said set of test samples on a build platform of an additive manufacturing system, each test sample being monitored by at least one electromagnetic sensor as it is being manufactured according to the 3D digital model, wherein each test sample is made up of two or more test coupons manufactured sequentially, for obtaining at least one optimized set of process parameters, and c. storing said at least one optimized set of process parameters for subsequent use during the building process of said at least one AM part, which is representative of a test coupon of a given acceptable quality factor.

The at least one optimized set of process parameters is obtained by carrying out the following steps: i. manufacturing at least two test coupons with two different sets of guess process parameters; ii. sensing said two test coupons with said at least one electromagnetic sensor; iii. changing for each new coupon at least one process parameter as a function of a) the previous sets of process parameters for the respective built test coupons, and b) the quality factor of respective test coupons measured by the electromagnetic sensor to obtain respective new sets of process parameters; iv. manufacturing an additional set of test coupons of respective test samples with said respective new set of process parameters; v. sensing the additional set of test coupons with said at least one electromagnetic sensor, vi. repeating steps iii. to v. until the predetermined geometry of each test sample is obtained.

A process parameters' window yielding an acceptable quality factor for said at least one AM part is then computed as a function of i) the sets of process parameters used for building the test coupon. The at least one optimized set of process parameters is selected within said process parameter window.

In an embodiment, said respective new set of process parameters (p_{i.j} . . . P_{n,m}) is obtained under step iii. by resampling i) a zone of the process parameters around the extremum of the quality factor derived from the electromagnetic sensor, or ii) a zone where the quality factor derived from the electromagnetic sensor is above a given threshold.

In an embodiment, a multivariate function of the quality factor of the test coupons of respective test samples as function of their respective sets of process parameters is obtained from the electromagnetic sensor data. An optimization algorithm such as the steepest descent algorithm, the conjugate gradient algorithm or the Monte-Carlo algorithm is used on the multivariate function to find said new sets of process parameters.

In an embodiment, a set of optimized process parameters is selected within the acceptance region where the gradient of said multivariate function is below a given threshold.

In an embodiment, a threshold of quality factor of the test coupon is determined, for example a given value of porosity, and wherein a constrained optimization is performed on at least one process parameter of said optimized set of process parameters (p_{i,opt}), for example the laser scanning speed, such that the new optimized set of process parameters is constrained within said process parameter window.

In an embodiment, each test sample cᵢ of the set of test samples (c₁, c₂ . . . c₁ . . . cₙ) comprises at least three test coupons (c_{i,1}, c_{i,2}, c_{i,3}), preferably at least five test coupons (c_{i,1}, c_{i,2}, c_{i,3}, c_{i,4}, c_{i,5}) arranged on top of each other.

In an embodiment, each test coupon (c_{i,1} . . . c_{i,j} . . . c_{i,m}), is made up of at least five layers, preferably at least ten layers such that the thickness of the coupon is larger than the penetration depth of the electromagnetic field generated by said at least one electromagnetic sensor.

In an embodiment, the method comprising manufacturing on the build platform a first test sample comprising a plurality of test coupons of different shapes arranged next to each other and manufacturing at least one additional test sample having a corresponding plurality of test coupons of shapes identical to the shapes of respective plurality of test coupons of the first test sample. The method comprises the steps of i. manufacturing the plurality of test coupons a first test sample with a unique set of process parameters per test coupon; ii. sensing each test coupon of said first test sample with said at least one electromagnetic sensor, and iii. changing at least one process parameter of each unique set of process parameters per coupon as a function of the data sensed for the corresponding test coupon to obtain a new set of process parameters for each test coupon.

In an embodiment, several optimized sets of process parameters are obtained during a single build cycle of the set of test samples. Each optimized set of process parameter is assigned to a specific geometry type and stored for subsequent use for building a portion zone of corresponding geometry of said at least one AM part.

In an embodiment, the test coupon of an acceptable quality level comprises a bulk density of at least 99%.

In an embodiment, said at least one electromagnetic sensor is an eddy-current sensor.

In an embodiment, a calibration sample of known density, conductivity or with known defects is measured at least once within the additive manufacturing system. The method further comprises the step of computing a lower bound and upper bound of said process parameters' window as a function of the raw electromagnetic sensor values obtained when sensing said calibration sample.

In an embodiment, once said at least one optimized set of process parameter has been obtained, a mapping of the build platform is generated as a function of a specific quality of the test coupon for a multitude of areas on the build platform corresponding to the specific position of each test sample on the build platform.

In an embodiment, the mapping is used to design a build platform layout excluding zones, on the build platform which have shown to produce test coupons of lesser quality in comparison with other test coupons, for additive manufacturing of said at least one AM part.

In an embodiment, said mapping is used to compensate for the inhomogeneity of the build process over the build platform by determining optimal position-dependent sets of process parameters such as laser scan speed, as a function of the position on the build platform, possibly by interpolation between the process parameters of the mapping. The optimal position-dependent sets of process parameters are transferred in an electronic format to a machine controller of the additive manufacturing system so that real AM parts are built with the corrected optimized set of process parameters corresponding to their X-Y position of the build plate to reach a uniform quality for all positions on the build platform.

In an embodiment, the method for optimizing one or more process parameters is carried out on different additive manufacturing machines or on the same machine at different points in time. The differences in quality level or differences in quality factor between the test coupons are used to classify the different machines as a function of the quality of the metal pieces that are manufactured in said machines or to detect a variation in the machine performance between two different times.

### BRIEF DESCRIPTION OF THE DRAWINGS

The invention will be better understood with the aid of the description of several embodiments given by way of examples and illustrated by the figures, in which:

FIG. 1 shows a schematic perspective view of set of test samples on a build platform to carry out a method for optimizing one or more process parameters of an additive manufacturing process according to an embodiment;

FIGS. 2 to 4 is a schematic view of different test samples comprising multiple coupons, whereby each coupon is built with a unique set of process parameters;

FIG. 5 is flow diagram of the additive manufacturing process for iteratively optimizing one or more process parameters during the manufacturing of one or more test samples to find an optimized set of process parameters according to the invention;

FIG. 6 is a schematic graph representing the concept of region of acceptable quality (or acceptance region) as a function of the variation of two process parameters, according to an embodiment;

FIG. 7 is a graph representing the correlation between the density of a part manufactured by a powder bed fusion process and the scan speed (all other process parameters being kept constant), wherein the density is determined by conventional methods (CT scanning, optical metallography and the Archimedes methods) and by the EC signal of an Eddy-current sensor;

FIGS. 8a to 8c are graphs representing the qualitative relationship between the density of a part manufactured by a powder bed fusion process and respectively the laser power, the hatch spacing and the layer thickness, (for each plot, only the process parameter indicated in the x-axis is varied), and

FIGS. 9a and 9b are schematic perspective views of different test samples with one control geometry per coupon.

### DETAILED DESCRIPTION OF POSSIBLE EMBODIMENTS OF THE INVENTION

In the context of the present invention, a test coupon shall be understood as a part made of a material of a given composition which is representative of an AM part or a portion of the AM part. The test coupon may be made of metal using different power bed fusion (PBF) technologies such as SLM (Selective Laser Melting), DMLS (Direct Metal Laser Sintering), SLS (Selective Laser Sintering), SHS (Selective Heat Sintering) and EBM (Electron Beam Melting) or other additive manufacturing technologies such as DED (Directed Energy deposition), WAAM (Wire Arc Additive Manufacturing), Liquid Metal Jetting, or metal extrusion. The test coupon may also be made of non-metallic material using for example the binder jetting technology. A test coupon is manufactured using the same process parameters during the build cycle of the test coupon.

Test coupons are designed to be sensed by electromagnetic sensors, for example Eddy-current sensors or capacitive sensors. Given that the penetration depth of the electromagnetic field produced by an eddy current sensor driven at a frequency in the 100-500 kHz range may vary approximately between 0.3 mm and 1 mm and that the thickness layer may vary between 20 and 120 μm, a coupon must comprise at least five layers and preferably at least ten layers in order that the uppermost sensed layers may provide coherent data on the quality of the test coupon.

A test sample shall be understood, in the context of the present invention, as a piece made of several test coupons. The test coupons may be built on top of each other as shown in FIGS. 2 to 4 and possibly next to each other as shown in FIGS. 9a and 9b, whereby each coupon is built with a set of process parameters which is generally unique in comparison with the other test coupons. Several test coupons sharing the same process parameters may be used after the optimization phase to characterize quality deviations caused by the position of the test coupon on the build plate and/or to check the stability of the part quality as function of time.

The quality of a test coupon is a multi-parameter criterion comprising probability of presence of defects, mechanical integrity, density of manufactured material (related to the presence of porosity), homogeneity of the manufactured material etc. The quality criteria may also be based on the fact the material has a defined microstructure.

An acceptable quality level is a series of conditions that have to be met for the part to be considered acceptable (fit for a given purpose). The acceptable quality level comprises rejection thresholds in a subset of the following defect or discontinuity classes: i) Surface discontinuities such as surface roughness or unevenness, with a rejection threshold being a roughness or surface unevenness amplitude; ii) Porosity, with a rejection threshold typically being a maximum tolerable pore size, pore density or pore cluster size threshold; iii) Cracking, with a rejection threshold typically being a maximum acceptable crack size (maximum crack depth and/or length); iv) Lack of fusion, with a rejection threshold typically being a maximum volume over which inadequate sintering has occurred; v) Part dimensions and part deformation, with rejections thresholds typically being dimensional or positional tolerances around a nominal position or dimension, wherein the position can be that of a surface of the AM part or the position of the last sintered layer and wherein the dimension is typically a distance between part features such a walls, surfaces or edges; vi) Part density, with a rejection threshold typically being a minimum local density; and vii) Residual stress, with a rejection threshold being a maximum acceptable stress.

The quality factor of a test coupon shall be understood, in the context of the present invention, as collection of measurements of physical properties a test coupon that qualifies the AM part quality. A part or coupon is considered to be fit for a given purpose when its quality factor meets all relevant testing requirements in the field of use of the AM part, i.e., when the collection of measurements performed on the part/coupon and constituting the quality factor shows that a given acceptable quality level is met. In general, the quality factor is a collection of (e.g. physical) properties, all of which have to satisfy a collection of acceptance criteria (i.e. are within an acceptance window or range) defined by the acceptable quality level to meet the quality requirements imposed by a norm or application standard to be considered usable.

The electromagnetic sensor may need to be calibrated to yield a quality factor, i.e. its raw digitized outputs may have to be subjected to a mathematical transformation to yield an accurate quality factor that can be used to determine reliably if a part monitored with said electromagnetic sensor meets the criteria associated with an acceptable quality level. In an advantageous embodiment, the parameters of this transformation may be set or adjusted using calibration samples representative of parts of a given or ideal quality level. One may for example use a calibration sample representative of an ideal quality level, such as bulk samples with a 100% density of the material used for the AM part, and an acceptable quality level may be a fraction of this bulk density In another embodiment, a calibration sample may be a part made of the same material used for the AM part with one or more defects sized around the threshold defined by the quality level may be used. Example of such defects may be cracks, surface roughness, or pores with a characteristic size similar to the maximum deemed as acceptable for a given quality level.

The quality factor as well as the productivity of the AM process are highly dependent of process parameters. It is therefore desirable to combine both part quality and process productivity considerations to find optimized process parameters. Typical optimization criteria may be for example: Environmental criteria such as the powder consumption per part or total energy expenditure per part; Economic criteria such as total cost per part, Productivity criteria such as part manufacturing time or usable fraction of the build volume; Robustness criteria such as the capacity of the process to yield acceptable parts over a broad range of poorly controlled parameters. Poorly controlled parameters could be the effective powder quality, uncontrolled machine-to-machine variations, or uncontrolled process variations. A combination of the above-mentioned optimization criteria may obviously be used. Another optimization criterion may be a part quality factor that is maximized for a given cost, time, powder consumption, or environmental impact per part.

Process parameters that influence the quality of an AM part generally fall into the following categories: energy beam (e.g. laser) and scanning parameters, powder bed properties, recoat parameters, and build environment parameters.

Laser and scanning parameters may comprise for example scan velocity (velocity at which laser beam moves across a build surface), scan spacing or hatch distance (distance between neighbouring laser passes), average power (measure of total energy output of a laser), mode (continuous wave or pulsed), beam shape, laser spot size in the processing plane and focus shift, beam compensation and offsets, other laser control parameters (skywriting, wobble, offsets, delays etc.), scanning strategies (parallel, paintbrush, chessboard, etc.) etc.

Powder bed properties may comprise for example layer thickness (height of a single power layer, impacting part resolution and process speed), powder layer density, powder layer quality (surface roughness, flatness, homogeneity etc.), power bed temperature (bulk temperature of the powder bed), thermal conductivity (measure of power bed's ability to conduct heat), deposition system parameters (e.g. recoater velocity, pressure, recoater type, number of deposition runs, feed factor). Build environment parameters may comprise for example shielding gas (usually Ar or N₂, but may also be He), oxygen level (oxygen can lead to oxide formation in metal), ambient temperature, build platform pre-heating temperature, build chamber pressure, gas flow velocity and temperature etc.

With reference to FIG. 6, a region of the process parameter space (or a process parameter window) corresponding to an acceptable quality factor can be explored using the method for optimizing one or more process parameters of the additive manufacturing process according to the invention. Using the measured quality factors from different test coupons manufactured with different sets of process parameters, a window of process parameters, which is generally multidimensional, may be assigned to an acceptance region of an acceptable quality level. Consequently, any part built with process parameters within this window is compliant for AM part certification which ensures AM parts meet the strict quality requirements demanded by the industry.

FIG. 6 shows a 2-dimension process parameter space for the sake of simplicity. However, the process parameter space is more likely to be of higher dimensions, i.e., a K-dimensional process parameter space, where the set of process parameters explored may be q₁, q₂, q₃ q₄ . . . qₖ, for example laser power q₁, hatch distance q₂, scanning speed q₃, layer thickness q₄, scanning strategies q₅, power bed temperature q₆, build chamber pressure q₇, etc.

For instance, for aero-engine components, which are subjected to high mechanical stresses, the test coupon may be considered to have an acceptable quality level if its relative density is above 99% (quality parameter 1) and if the longest surface breaking crack does not exceed 2 mm (quality parameter 2). Conversely, AM parts which are not subjected to high mechanical stresses may have a degree of porosity such that the relative density of a test coupon below 95% is still considered to have an acceptable quality level.

Only a fraction of the above-mentioned process parameters is usually modified in order to find the process window of the process parameters that may create an object with an acceptable quality level. The most influential process parameters are Laser power P [W], Hatch distance h [μm], Scanning speed v[mm/s] and layer thickness t[μm].

These process parameters are included in the Volumetric Energy Density VED [J/mm³] equation:

$$VED = \frac{P}{h \cdot t \cdot v}$$

It is well established that the VED must be in a certain range for instance between 50 J/mm³ and 200 J/mm³ for 316L stainless steel (alloy dependent values), to obtain an optimum component density. In the method for optimizing one or more process parameters of an additive manufacturing process using for example power bed fusion as described therein, initial guess parameters p_{i,1} must first be determined. The VED may be used to determine the initial guess parameters although the VED is a simplified model, which does not capture all the physics of the printing process. The variables of the above equation may be set arbitrary so that the VED is between the lower and upper thresholds. Alternatively, the process parameters influencing production time may be set to a desired time and the other variables may be adapted to ensure that the VED is between these lower and upper thresholds.

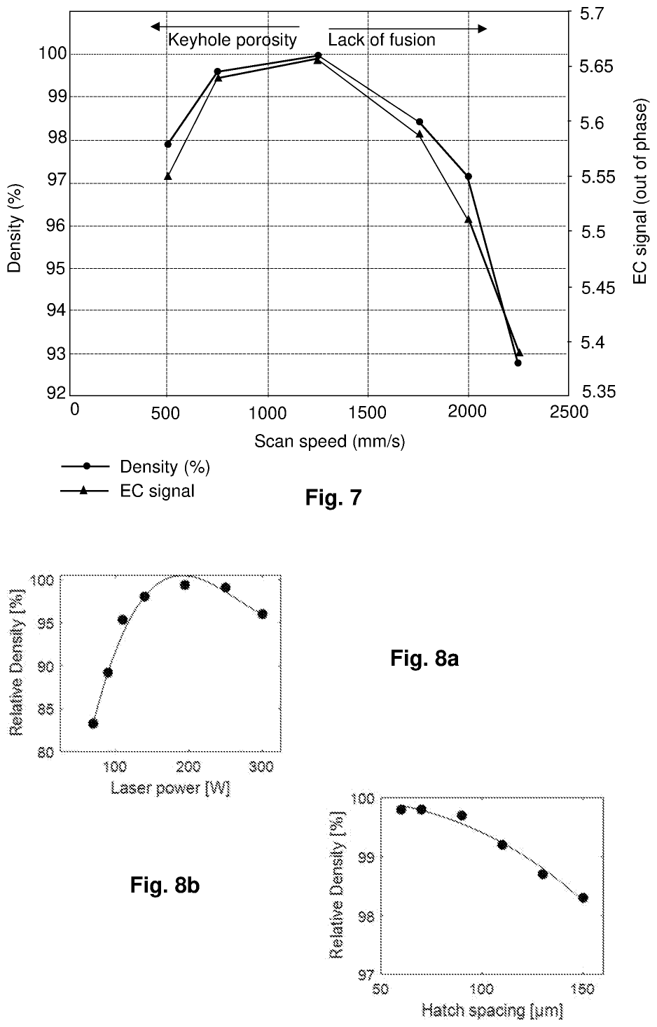

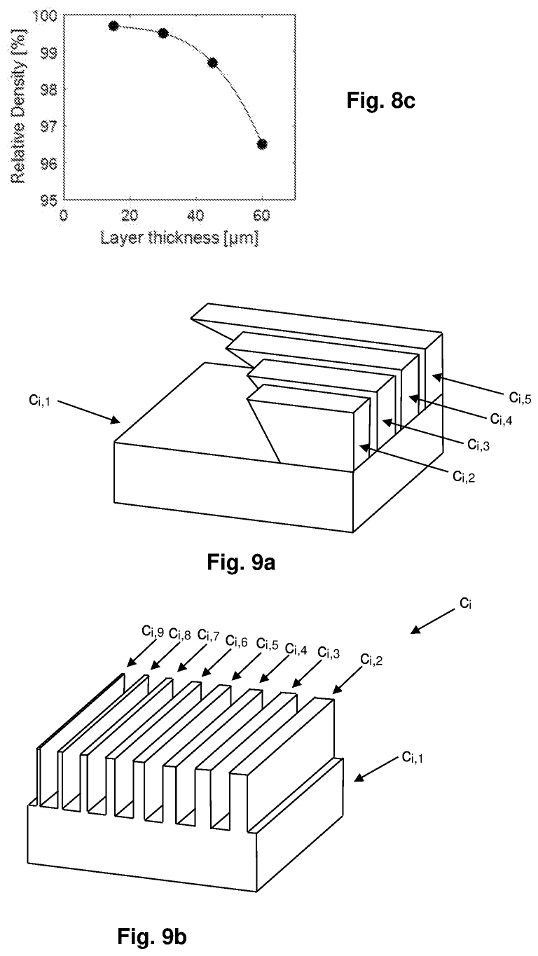

As shown by FIG. 7 and FIGS. 8a to 8c, the variation of any of these variables, i.e. hatch distance h, scanning speed v, layer thickness t and laser power P, has a significant impact on the relative density of the test coupon.

For each iterating step, one or more of these variables of the VED equation are changed until an optimized set of process parameters is found. Other process parameters that influence that quality of an AM part, as thoroughly described above, may be varied.

If one considers the 4 independent parameters of the VED equation, and 5 values per parameter, this results in 625 different parameter sets. A systematic exploration of parameter sets is therefore extremely tedious if not impossible with the usual methods.

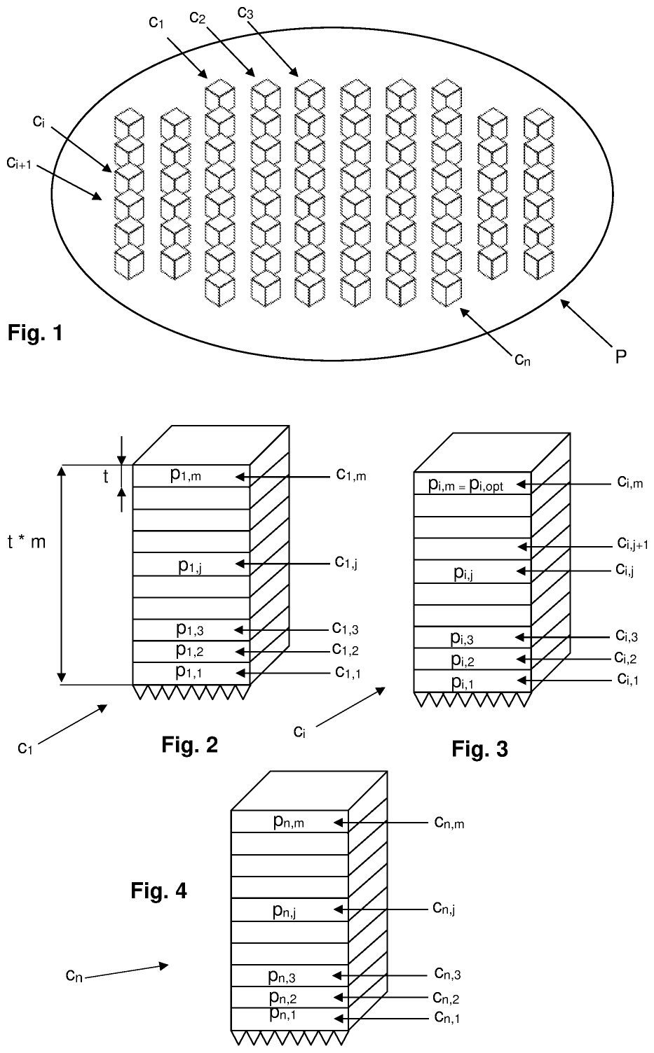

With reference to FIGS. 1 to 4, each test sample of the set of test samples, labelled c₁, c₂ . . . c₁ . . . cₙ, comprises several test coupons labelled c_{i,1}, c_{i,2}, c_{i,3}, . . . c_{i,m}. At least one test sample is manufactured on the build platform P, preferably a set of test samples c₁, c₂ . . . c₁ . . . cₙ, wherein the test sample or each test sample is designed to comprise at least two different test coupons c_{i,1} . . . c_{i,j} . . . c_{i,m} on top of each other.

Each test coupon c_{i,j} is arranged to be manufactured with a unique set of process parameters, p_{i,j}. Increasing the number of calibrations samples and the number of test coupons per test sample increases considerably the number of sets of process parameters that can be explored during a single build cycle. For example, assuming that there are eight calibrations samples to be manufactured, whereby each test sample comprises 20 test coupons, then 160 sets of process parameters can be investigated during the build cycle to find at least one set of optimal process parameters for at least one AM part to be printed or a portion thereof. At least one process parameter is changed for each new set of process parameters p_{i,j}+1 as a function of the previous sets of process parameters for the respective built test coupons, and b) the quality levels of respective test coupons based on a quality factor measured by the electromagnetic sensor to obtain the new set of process parameters p_{i,j}+1. The previous sets of process parameters shall be understood as all the sets of process parameters used for building the first coupon to the last coupon or a subset of these test coupons. For example, if 100 test coupons have been built with 100 different sets of process parameters, then the new set of process parameters is generated based on i) said 100 different sets of process parameters or a subset, for example 90 different sets of process parameters and ii) the quality factor of all the test coupons built with these process parameters.

In an embodiment, a quality of a test coupon is sensed by one or more electromagnetic (e.g. Eddy-current) sensors (not shown) which may be mounted on the recoater of an additive manufacturing machine, for example a SLM machine, next to each other along an axis perpendicular to the direction of displacement of the recoater in the horizontal plane. In an alternative embodiment, the electromagnetic sensors may be mounted on a sensor supporting structure which is independent of the recoater. The electromagnetic sensors are arranged next to each other along an axis substantially perpendicular to the direction of the displacement of the sensor supporting structure across the build platform.

The quality of a test coupon (or a region of a real part), a (potentially multi-dimensional) quality factor is built from the response measured by the electromagnetic response sensors (and possibly others). This quality factor is therefore related to the quality of a part for a particular purpose and is compliant with non-destructive testing (NDT) norms. It means that a test coupon or a really manufactured part with a sufficiently good quality factor can be considered as compliant for the particular purpose. For instance, the absence of porosity and the absence of embedded cracks may guarantee that the manufactured part is compliant. One simple example of such a quality factor is the local material density inferred from the measured electromagnetic response of the electromagnetic sensor(s).

Referring to FIGS. 1 to 4, a set of test samples c₁ . . . c₁ . . . cₙ is built on the building platform P of the additive manufacturing system according to the 3D digital model which was generated on a computing device. Each test sample cᵢ is made up of test coupons c_{i,1} . . . c_{i,j} . . . c_{i,m}. A first test coupon c_{1,1} . . . c_{i,1} . . . c_{n,1} of each test sample is first built with the initial guess set(s) of parameters p_{1,1} . . . p_{i,1} . . . p_{n,1}. The electromagnetic sensors may be arranged on the recoater to move above each newly built layer of the test coupon of each test sample in order to sense the test coupon as it is being built.

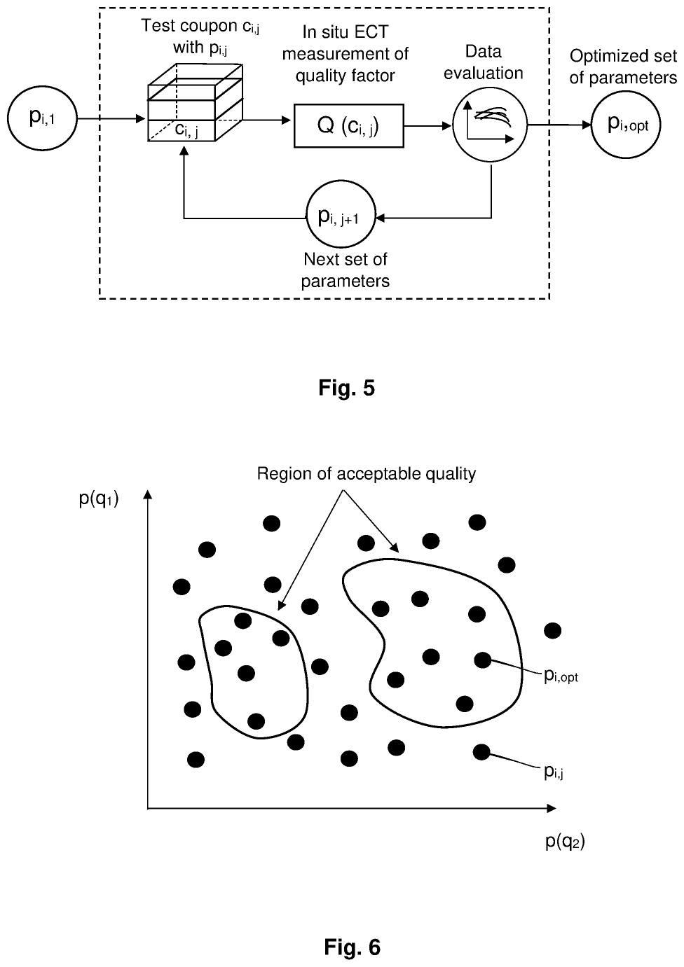

As illustrated by FIG. 5, at least one process parameter of the initial guess parameters p_{i,1} is changed as a function of the data sensed by the electromagnetic sensor in order to obtain a second set(s) of process parameters p_{i,2} or p_{i,j}+1 for building a second test coupon c_{i,2}. The process is iterated with additional sets of parameters p_{i,1}, p_{i,2} . . . p_{i,m} in order to converge to an optimized set of process parameters p_{i,opt} which will be used to manufacture an AM part or a portion of the AM part with an acceptable quality level for its application.

Optionally, only data corresponding to the uppermost layers of a given test coupons are used for determining the next set of process parameters to converge to an optimal set of process parameters pₒₚₜ or set of sets of parameters p_{i,opt} as data obtained from underlying layers may be incoherent since the penetration depth of the electromagnetic field produced by the electromagnetic sensors may exceed the thickness of the built layers.

Alternatively, the electromagnetic sensors may be arranged to move above each test coupon once completed to acquire data relative to the quality of the test coupon, in particular on the degree of porosity of the test coupon which can be determined using the EC signal as shown in FIG. 7.

The optimisation method may be aimed at finding the process parameters providing for example the highest relative part density. In embodiments using Eddy-current sensors, this is done using the fact that the extremum of the component of the eddy current signal corresponding to the electrical conductivity is also an extremum of the part density as shown in FIG. 7. The results of the eddy current measurements of the respective test coupons are plotted as a function of the process parameters that have been varied. The optimisation problem can then be reduced to an extremum search.

Various optimization algorithms can be used to find this extremum, such as the steepest descent, conjugate gradient and Monte-Carlo algorithms, in order to generate new sets of process parameters for manufacturing a corresponding new set of test coupons with quality factor expected to be closer to the acceptable quality level.

In an advantageous embodiment, each test sample cᵢ comprises several test coupons of different shapes. FIGS. 9a and 9b are examples of test samples comprising each several test coupons of different shapes. For example, with reference to FIG. 9a, the initial test coupon c_{i,1} is for example a 10×10×2.5 mm³ cube for optimizing the set of process parameters for bulk material while the additional test coupons are distinctive adjacent cantilever portions c_{i,2}, c_{i,3}, c_{i,4}, c_{i,5} of different inclinations allowing to find an optimized set of process parameters p_{i,opt} for each inclination.

In another example illustrated in FIG. 9b, the initial test coupon c_{i,1} is also a similar cube while the additional test coupons are distinctive adjacent wall portions c_{i,2}, c_{i,3}, c_{i,4}, c_{i,5}, c_{i,6}, c_{i,7}, c_{i,8} of different thickness allowing to find an optimized set of process parameters p_{i,opt} for each thickness.

The method can be straightforwardly extended to find the optimized set of process parameters p_{i,opt} for each specific shape, for each cantilever and wall portion in the illustrated example. For this, two or more calibrations samples, with coupons of the same specific shapes, must be built. More particularly, the following steps must be performed: i) manufacturing each test coupon c_{i,j} of the two or more test samples, each with a set of process parameters p_{i,j}; ii) sensing each test coupon of said one of the at least two test samples; iii) changing at least one process parameter of each set of process parameters p_{i,j} as a function of the data sensed for the corresponding test coupon c_{i,j} to obtain an improved set of process parameters for each test coupon, iv) manufacturing each test coupon c_{i,j}+1 with the new sets of improved process parameters p_{i,j}+1, and v) repeating steps ii) to iv) to obtain a list of process parameter sets p_{i,1} . . . p_{i.j}, . . . , p_{i,m} for each specific shape to allow the determination of an optimized set of process parameters p_{i,opt} for each shape.

Depending on the specific shapes being investigated, for instance if the shape contains parts containing oblique parts, cantilever portions or overhangs, the test coupons may include a vertical support structure used to allow the manufacturing of these special geometries. Both the bulkier support structure and the actual specific shape can be sensed by one or more electromagnetic sensors and optimized independently.

When multiple AM parts are printed within one build cycle, layout and location of the parts on the build platform can be critical. The quality of the AM part can vary between different locations on the build platform. To address this issue, once the optimized set of parameters p_{i,opt} has been found after multiple iterating steps, an additional test coupon c_{i,m}+1 is built on top of each test sample using respective optimized set of process parameters p_{i,opt}. The additional test coupon c_{i,m}+1 of each test sample is then sensed by at least one electromagnetic sensor (e.g. Eddy-current sensor) to determine the quality (e.g. porosity) of each additional test coupon of the set test samples with respect to the specific position of each test sample on the build platform. A mapping of the build platform P is then realized as a function of a specific quality (e.g. porosity) of each additional test coupon c_{i,m}+1 and their specific location on the build platform.

This mapping may then be used to design a build platform layout excluding zones on the build platform which have shown to produce test coupons of lesser quality in comparison with other test coupons.

In another embodiment, the mapping may be used to modify one or more process parameters of respective sets of optimized process parameters p_{i,opt}, such as laser scan speed, to obtain a X-Y position-dependent optimized sets of process parameters to reach a uniform quality on the build platform. The modified optimized set of process parameters for each specific position on the build platform may then be saved for manufacturing an AM part or a portion of the AM part which is representative of the test coupon.

The optimisation data collected with the methods described above (i.e. the optimised parameters, the quality factors obtained for each parameter set, the variations across the build plate, among other) are characteristic of the AM machine type. Assuming that the same powder is used, all the machines of the same type should give very similar optimisation data, with small machine to machine variations reflecting the tolerances in the machine design, components, fabrication, and assembly. Small, acceptable variations in the optimisation data, for instance caused by the aging of some components, can be corrected by applying the method for optimizing one or more process parameters of the additive manufacturing process according to the invention and modifying the corresponding fabrication parameters accordingly.

Also, performing at regular time intervals the method for optimizing one or more process parameters of the additive manufacturing process according to the invention can advantageously be used in the frame of machine maintenance procedure to verify that the AM machine is performing according to its specifications. The optimisation data obtained at a certain point in the machine lifetime must be in the acceptable range defined by the user or the Original Equipment Manufacturers (OEM). Finally, the comparison of the optimisation data with reference values obtained on a reference machine can be used by the machine manufacturer as part of the machine pre-delivery inspection procedures.

The method for optimizing one or more process parameters of the additive manufacturing process according to the invention may also be used to classify the different machines as a function of the quality of the metal pieces they can manufacture. This classification may then advantageously be used for maintenance of the additive manufacturing machines that have produced test samples of significant lower quality as compared to other machines.

The acceptance region of process parameter space as described above notably with reference to FIG. 6 can be constructed during the optimization process to maximize the quality (search for the optimum). In an embodiment, the inclusion of additional sets of process parameters beyond the found accepted quality may be advantageously forced, i.e. it is advantageous not to stop the search for the optimum quality when the lowest acceptable quality factor (i.e., the multi-dimensional quality factor just within the acceptable bounds defined by a given acceptable quality level) has been reached but to include some additional sets of process parameters (and the corresponding test coupons) beyond that point to better evaluate the boundaries of this acceptance region. The acceptance region may consist in several disconnected regions as shown in FIG. 6 (i.e. the concept of acceptance region does imply neither connectivity nor convexity).

In an embodiment, the boundaries of the acceptance region of the process parameters space are obtained by interpolation if the measured quality factors do not fall precisely on the limit acceptance values. In a multi-dimensional case, this is done for instance by an interpolation (linear in the simplest case but not limited to this) within the simplices obtained by tessellation of the multi-dimensional process parameter space. As an extension, other space tessellation can be used producing other types of elements than simplices (e.g. quads, hexagonal tessellation, etc.).

In an embodiment, the acceptance region is used to perform an additional optimization over the process parameters with a different criterion than quality, e.g. the manufacturing speed (i.e. the set of process parameters within the acceptance region which minimize the manufacturing time).

In an embodiment, the acceptance region in the process parameter space is transferred to a quality optimization algorithm used during the manufacturing of real parts to constrain the optimization algorithm to the region of acceptable quality. This quality optimization algorithm may be completely independent from the one used to determine the quality acceptance region in process parameters and may rely on a completely different set of sensors to perform its task.

This ensures that produced real AM parts are compliant irrespective of the decision of the quality optimization algorithm since it is constrained to remain within the region of acceptable quality. In addition, it provides a level of explainability of the quality optimization algorithm. Without this, there can be no guarantee that the process parameters determined by said quality optimization algorithm during the manufacturing of real AM parts remain in a region of process parameters ensuring the compliance of produced parts.

1. A method for optimizing one or more process parameters of an additive manufacturing process, comprising, prior to the step of manufacturing at least one AM part, the steps of:
a. generating, on a computing device, a 3D digital model of a set of test samples to be manufactured by the additive manufacturing process, wherein each test sample has a predetermined geometry;
b. manufacturing said set of test samples on a build platform of an additive manufacturing system, each test sample being monitored by at least one electromagnetic sensor as it is being manufactured according to the 3D digital model, wherein each test sample is made up of two or more test coupons manufactured sequentially, for obtaining at least one optimized set of process parameters, and
c. storing said at least one optimized set of process parameters for subsequent use during the building process of said at least one AM part, which is representative of a test coupon of a given acceptable quality factor,
wherein said at least one optimized set of process parameters is obtained by carrying out the following steps:
i. manufacturing at least two test coupons with two different sets of guess process parameters,
ii. sensing said two test coupons with said at least one electromagnetic sensor,
iii. changing for each new coupon at least one process parameter as a function of a) the previous sets of process parameters for the respective built test coupons, and
b) the quality factor of respective test coupons measured by the electromagnetic sensor to obtain respective new sets of process parameters,
iv. manufacturing an additional set of test coupons of respective test samples with said respective new set of process parameters,
v. sensing the additional set of test coupons with said at least one electromagnetic sensor,
vi. repeating steps iii. to v. until the predetermined geometry of each test sample is obtained,
wherein a process parameters' window yielding an acceptable quality factor for said at least one AM part is computed as a function of
the sets of process parameters used for building the test coupons of respective test samples, and
the quality factor of said test coupons, and
wherein said at least one optimized set of process parameters is selected within said process parameter window.

2. The method of claim 1, wherein said respective new set of process parameters is obtained under step iii. by resampling
a zone of the process parameters around the extremum of the quality factor derived from the electromagnetic sensor, or
a zone where the quality factor derived from the electromagnetic sensor is above a given threshold.

3. The method of claim 1, wherein a multivariate function of the quality factor of the test coupons of respective test samples as function of their respective sets of process parameters is obtained from the electromagnetic sensor data, and wherein an optimization algorithm such as the steepest descent algorithm, the conjugate gradient algorithm or the Monte-Carlo algorithm is used on the multivariate function to find said new sets of process parameters.

4. The method of claim 3, wherein a set of optimized process parameters is selected within the acceptance region where the gradient of said multivariate function is below a given threshold.

5. The method of claim 1, wherein a set of optimized process parameters is selected within the acceptance region based on productivity criteria such as the coupon manufacturing time.

6. The method of claim 1, wherein each test sample of the set of test samples comprises at least three test coupons, preferably at least five test coupons arranged on top of each other.

7. The method of claim 1, wherein each test coupon, is made up of at least five layers, preferably at least ten layers such that the thickness of the coupon is larger than the penetration depth of the electromagnetic field generated by said at least one electromagnetic sensor.

8. The method of claim 1, comprising manufacturing on the build platform a first test sample comprising a plurality of test coupons of different shapes arranged next to each other and manufacturing at least one additional test sample having a corresponding plurality of test coupons of shapes identical to the shapes of respective plurality of test coupons of the first test sample, wherein step b. of claim 1 comprises:
i. manufacturing the plurality of test coupons of a first test sample with a unique set of process parameters per test coupon;
ii. sensing each test coupon of said first test sample with said at least one electromagnetic sensor, and
iii. changing at least one process parameter of each unique set of process parameters per coupon as a function of the data sensed for the corresponding test coupon to obtain a new set of process parameters for each test coupon.

9. The method of claim 1, wherein several optimized sets of process parameters are obtained during a single build cycle of the set of test samples, each optimized set of process parameters being assigned to a specific geometry type and stored for subsequent use for building a portion zone of corresponding geometry of said at least one AM part.

10. The method of claim 1, wherein the test coupon of an acceptable quality level comprises a bulk density of at least 99%.

11. The method of claim 1, wherein said at least one electromagnetic sensor is an eddy-current sensor.

12. The method of claim 1, wherein a calibration sample of known density, conductivity or with known defects is measured at least once within the additive manufacturing system, the method further comprising the step of computing a lower bound and upper bound of said process parameters' window as a function of the raw electromagnetic sensor values obtained when sensing said calibration sample.

13. The method of claim 1, wherein once said at least one optimized set of process parameters has been obtained, a mapping of the build platform is generated as a function of a specific quality for a multitude of areas on the build platform corresponding to the specific position of each test sample on the build platform.

14. The method of claim 13, wherein said mapping is used to design a build platform layout excluding zones, on the build platform which have shown to produce test coupons of lesser quality in comparison with other test coupons, for additive manufacturing of said at least one AM part.

15. The method of claim 13, wherein said mapping is used to compensate for the inhomogeneity of the build process over the build platform by determining optimal position-dependent sets of process parameters such as laser scan speed, as a function of the position on the build platform, possibly by interpolation between the process parameters of the mapping, wherein said optimal position-dependent sets of process parameters are transferred in an electronic format to a machine controller of the additive manufacturing system so that real AM parts are built with the corrected optimized set of process parameters corresponding to their X-Y position of the build plate to reach a uniform quality for all positions on the build platform.

16. The method of claim 15, wherein the step b. is carried out on different additive manufacturing machines or on the same machine at different points in time, and wherein the differences in quality level or differences in quality factor between the test samples are used to classify the different machines as a function of the quality of the metal pieces that are manufactured in said machines or to detect a variation in the machine performance between two different times.
